(19) United States
(12) Patent Application Publication
(10) Pub. No.: US 2012/0027380 A1
(43) Pub. Date: Feb. 2, 2012

(54) AUTOMATICALLY BOOKMARKING DIGITAL CONTENT

(75) Inventors: Andrew Marsh, Kilrush (IE); Craig McKinley, Kitchener (CA); Richard Czegledi, Waterloo (CA)

(73) Assignee: KALEIDESCAPE, INC., Sunnyvale, CA (US)

(21) Appl. No.: 13/019,140

(22) Filed: Feb. 1, 2011

Related U.S. Application Data
(60) Provisional application No. 61/324,558, filed on Apr. 15, 2010.
(60) Provisional application No. 61/300,766, filed on Feb. 2, 2010.

(51) Int. Cl. H04N 9/80

(52) U.S. Cl. 386/241; 386/E05.003

(57) ABSTRACT

Described herein are embodiments of systems and methods relating to bookmarking digital content. In one such embodiment, a method of bookmarking digital content is described. The method involves locating digital content and obtaining navigation information associated with the digital content. From this navigation information, bookmark information is calculated.

### CROSS REFERENCE TO RELATED APPLICATIONS

This application claims priority to and the benefit under 35 U.S.C. §119(e) of copending U.S. Provisional Patent Application No. 61/324,558, entitled “BOOKMARKING DIGITAL CONTENT ON BLU-RAY DISCS” by Hindle et al., filed on Apr. 15, 2010, and to U.S. Provisional Patent Application No. 61/300,766, entitled “AUTOMATICALLY BOOKMARKING DIGITAL CONTENT” by Marsh et al., both of which are hereby incorporated by reference as if fully set forth herein.

### BACKGROUND

1. Field of the Invention

Embodiments of the present invention relate to automatically bookmarking digital content.

2. Related Art

One of the challenges inherent to manipulation of digital media is identifying the content. Some content formats, such as MP3, allow for relatively easy identification. Such formats often encode identifying metadata within the format itself; in the case of the MP3 format, information such as the song name, artist name, and source album can be included within the file when it is distributed. Other formats do not offer this easy approach to content identification; in the case of DVD, the format only allows for an 11 character string. In practice, this character string is insufficient to ensure unique identification of a particular DVD. Additionally, it is sometimes useful to independently identify digital media irrespective of any embedded identification information; this helps address problems arising from mislabeling of content.

One particular challenge is identifying content when the delivery package is altered. For example, a single motion picture may be released many different times over the course of its commercial life. Current approaches for identifying DVDs, such as generating a hash value, are very precise; they uniquely identify a particular DVD, based on all the content included on the disc. Where these current approaches fail is in attempting to identify a DVD containing the same main feature as a known DVD, but with changes to the supplementary content included on the disc. The inclusion of a single thirty second trailer on one disc, but not on the other, is sufficient to prevent identification using current methods.

Another challenge arising from digital media is navigating within a package of content. For example, a commercial DVD generally contains a number of pieces of content in addition to the main feature, such as trailers for other movies, copyright notices, outtakes, “behind the scenes” documentaries. It is desirable to enable users to navigate directly to a content that interests them without having to navigate the DVD menu structure. One approach to enabling users in this fashion is bookmarking, where metadata is provided that allows a playback device to access the DVD at a specified location corresponding to the desired content, such as the main feature on the DVD. At present, bookmarking a DVD requires access to a copy of the physical disc itself, as the exact location of the main feature on the DVD will differ for every feature, and even between different pressings of the same feature. One such approach to bookmarking and creating watchpoints is detailed in U.S. Patent Publication 2004/0139047, entitled “BOOKMARKS AND WATCHPOINTS FOR SELECTION AND PRESENTATION OF MEDIA STREAMS” by Rechsteiner et al., which is hereby incorporated by reference. Similar techniques apply to other forms of digital content distribution, with similar restrictions.

### SUMMARY

Described herein are embodiments of systems and methods relating to bookmarking digital content. In one such embodiment, a method of bookmarking digital content is described. The method involves locating digital content and obtaining navigation information associated with the digital content. From this navigation information, bookmark information is calculated.

Another embodiment described herein details a method of bookmarking digital content. In this embodiment, navigation information is obtained, associated with digital content to be bookmarked. Playback information is extracted from this navigation information. A bookmark is then calculated for the digital content, with reference to the playback information.

Another embodiment described herein discusses a system for calculating a bookmark for digital content. The system includes a bus for communicating information; a processor, coupled to the bus, for processing information and instructions; a memory, coupled to the bus, for storing such instructions; and a storage device, coupled to the bus, for storing navigation information associated with the digital content. The processor is configured to perform the instructions, in order to extract playback information from the navigation information. The processor can then calculate the bookmark for the digital content.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 depicts an exemplary computer system, upon which embodiments may be implemented.

FIG. 2 depicts an exemplary media server environment, in accordance with one embodiment.

FIG. 3 depicts an exemplary media server environment, in accordance with one embodiment.

FIG. 4 depicts a representation of the structure of the content of a DVD, in accordance with one embodiment.

FIG. 5 depicts representations of the structure of DVDs, in accordance with one embodiment.

FIG. 6 depicts a method of digital content identification, in accordance with one embodiment.

FIG. 7 depicts a method of automatically generating bookmarks for digital content, in accordance with one embodiment.

FIG. 8 depicts a method of remotely generating bookmarks for digital content, in accordance with one embodiment.

FIG. 9 depicts a method of calculating bookmarks from navigation information, in accordance with one embodiment.

FIG. 10 depicts a method of calculating bookmarks from playback duration signature, in accordance with one embodiment.

FIG. 11 depicts a method of calculating bookmarks from playback duration signature, in accordance with one embodiment.

FIG. 12 depicts a method of identifying episodic content, in accordance with one embodiment.

### DETAILED DESCRIPTION

Reference will now be made in detail to several embodiments of the invention. While the invention will be described in conjunction with the alternative embodiment(s), it will be understood that they are not intended to limit the invention to these embodiments. On the contrary, the invention is intended to cover alternative, modifications, and equivalents, which may be included within the spirit and scope of the invention as defined by the appended claims.

Furthermore, in the following detailed description, numerous specific details are set forth in order to provide a thorough understanding of the claimed subject matter. However, it will be recognized by one skilled in the art that embodiments may be practiced without these specific details or with equivalents thereof. In other instances, well-known methods, procedures, components, and circuits have not been described in detail as not to unnecessarily obscure aspects and features of the subject matter.

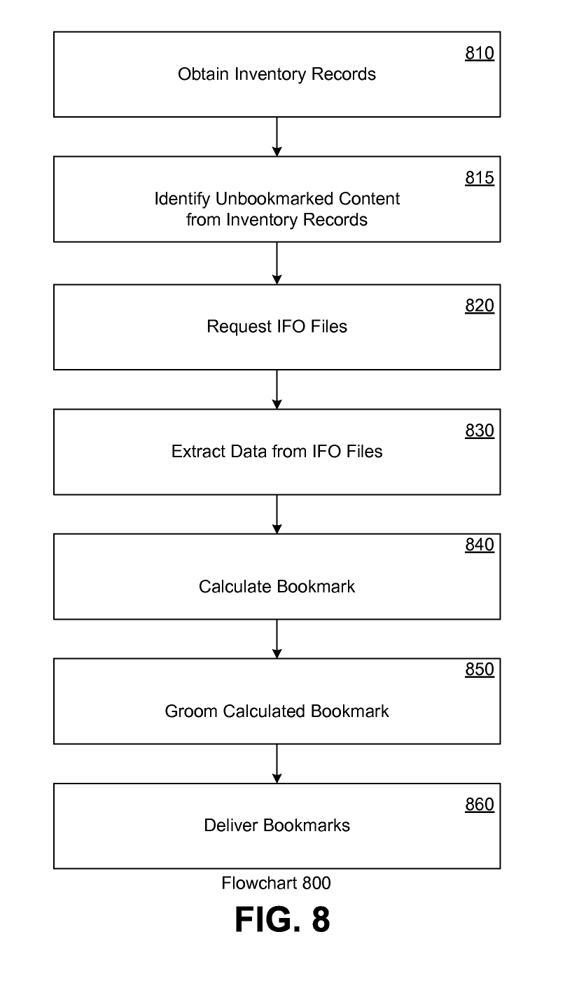

Portions of the detailed description that follows are presented and discussed in terms of a method. Although steps and sequencing thereof are disclosed in figures herein (e.g., FIG. 8) describing the operations of this method, such steps and sequencing are exemplary. Embodiments are well suited to performing various other steps or variations of the steps recited in the flowchart of the figure herein, and in a sequence other than that depicted and described herein.

Some portions of the detailed description are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer-executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout, discussions utilizing terms such as “accessing,” “writing,” “including,” “storing,” “transmitting,” “traversing,” “associating,” “identifying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Computing devices typically include at least some form of computer readable media. Computer readable media can be any available media that can be accessed by a computing device. By way of example, and not limitation, computer readable medium may comprise computer storage media and communication media. Computer storage media includes volatile and nonvolatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other medium which can be used to store the desired information and which can be accessed by a computing device. Communication media typically embodies computer readable instructions, data structures, program modules, or other data in a modulated data signals such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer readable media.

Some embodiments may be described in the general context of computer-executable instructions, such as program modules, executed by one or more computers or other devices. Generally, program modules include routines, programs, objects, components, data structures, etc., that perform particular tasks or implement particular abstract data types. Typically the functionality of the program modules may be combined or distributed as desired in various embodiments.

### Basic Computing System

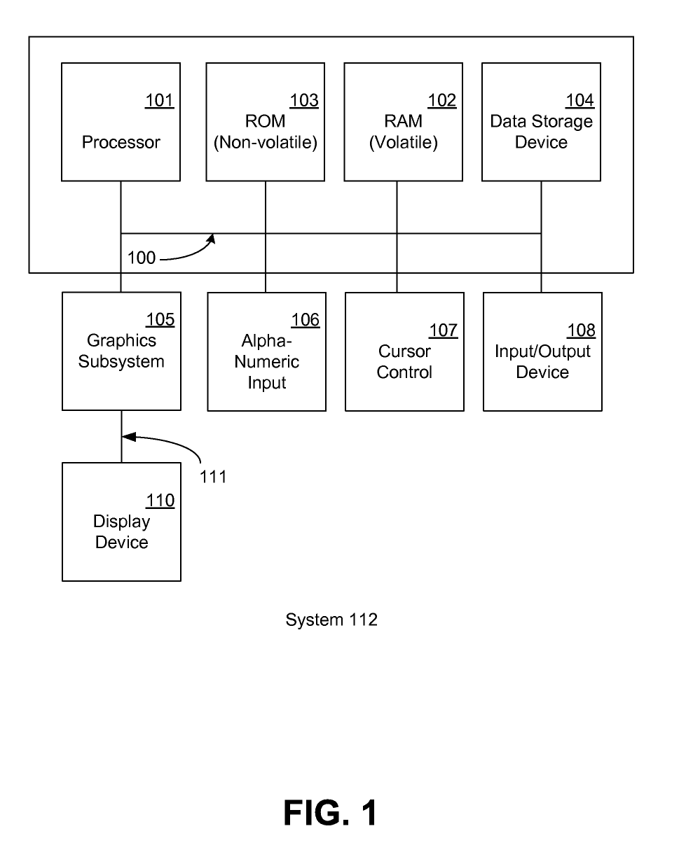

Referring now to FIG. 1, a block diagram of an exemplary computer system 112 is shown. It is appreciated that computer system 112 described herein illustrates an exemplary configuration of an operational platform upon which embodiments may be implemented to advantage. Nevertheless, other computer systems with differing configurations can also be used in place of computer system 112 within the scope of the present invention. For example, computer system 112 may include additional, fewer, or different elements other than those described in conjunction with FIG. 1. Moreover, embodiments may be practiced on any system which can be configured to enable it, not just computer systems like computer system 112. It is understood that embodiments can be practiced on many different types of computer system, including system 112. System 112 can be implemented as, for example, a desktop computer system or server computer system having a powerful general-purpose CPU coupled to a dedicated graphics rendering GPU. In such an embodiment, components can be included that add peripheral buses, specialized audio/video components, IO devices, and the like. Similarly, system 112 can be implemented as a handheld device (e.g., cellphone, etc.) or a set-top video game console device such as, for example, the Xbox®, available from Microsoft Corporation of Redmond, Wash., or the PlayStation3®, available from Sony Computer Entertainment Corporation of Tokyo, Japan. System 112 can also be implemented as a “system on a chip”, where the electronics (e.g., the components 101, 103, 105, 106, and the like) of a computing device are wholly contained within a single integrated circuit die. Examples include a hand-held instrument with a display, a car navigation system, a portable entertainment system, and the like.

Computer system 112 comprises an address/data bus 100 for communicating information, a processor 101 coupled with bus 100 for processing information and instructions; a volatile memory unit 102 (e.g., random access memory [RAM], static RAM, dynamic RAM, etc.) coupled with bus 100 for storing information and instructions for processor 101; and a non-volatile memory unit 103 (e.g., read only memory [ROM], programmable ROM, flash memory, etc.) coupled with bus 100 for storing static information and instructions for processor 101. Moreover, computer system 112 also comprises a data storage device 104 (e.g., hard disk drive) for storing information and instructions.

Computer system 112 also comprises an optional graphics subsystem 105, an optional alphanumeric input device 106, an optional cursor control or directing device 107, and signal communication interface (input/output device) 108. Optional alphanumeric input device 106 can communicate information and command selections to central processor 101. Optional cursor control or directing device 107 is coupled to bus 100 for communicating user input information and command selections to processor 101. Signal communication interface (input/output device) 108, which is also coupled to bus 100, can be a serial port. Communication interface 108 may also include wireless communication mechanisms. Using communication interface 108, computer system 112 can be communicatively coupled to other computer systems over a communication network such as the Internet or an intranet (e.g., a local area network), or can receive data (e.g., a digital television signal). Computer system 112 may also comprise graphics subsystem 105 for presenting information to the computer user, e.g., by displaying information on an attached display device 110, connected by a video cable 111, or by transmitting information to a display via a wireless connection (not pictured). In some embodiments, graphics subsystem 105 is incorporated into processor 101. In other embodiments, graphics subsystem 105 is a separate, discrete component. In other embodiments, graphics subsystem 105 is incorporated into another component. In other embodiments, graphics subsystem 105 is included in system 112 in other ways.

### Utilizing Navigation Information in Digital Content

The following embodiments help describe an approach for identifying digital content from inherent navigation information included with the content. For example, the IFO files included on a DVD can be used to help identify the content included on the DVD. This approach is particularly useful for identifying different pressings of a particular feature. The same motion picture, for example, may be released on many different DVDs over the course of its commercial life; the approach described herein seeks to identify each of those commercial releases as containing the same motion picture.

This approach involves examination of the cell structure of one or more program chains defined in the IFO files. The program chain corresponding to the main feature is identified, and the cell structure of the program chain is compared against the cell structures of known programs. By focusing the analysis on the main feature included on the disc, extraneous information such as changes in movie trailers also included on the DVD will not affect the identification process as much.

Also described herein are approaches to automatically generate bookmarks for digital content, by examining the inherent navigation information included with that content. As previously discussed, it is advantageous to provide bookmarks (or bookmark/watchpoint pairs) for digital content, and specifically for one or more media objects contained within the digital content; for example, a given DVD or Blu-ray Disc may contain many different media objects: a movie; trailers or previews; special features or interviews; episodes of a TV series; or a play-all episodes media object. Given the collection of media objects represented by a package of digital content, it may be useful to automate the creation of a bookmark, or bookmark/watchpoint pair, to allow ready access to one or more of the media objects.

In order to create such a bookmark, some embodiments attempt to first identify the media object to be bookmarked. Several approaches are described below. For example, the IFO files included with a DVD can often be utilized to automatically identify an appropriate bookmarking location, as well as to distinguish episodic content, such as DVD collections of a television program, from single-feature content, such as a motion picture included on a DVD. Other identification approaches may be utilized as well, such as calculating a fingerprint or hash value for the digital content, and comparing that identifier against an available list or database.

Once the desired media object or objects are identified, navigation information associated with the digital content can be used to create the relevant bookmark, or bookmark/watchpoint pair. In one such case, bookmarking a DVD involves identifying the title number, program chain number, time in seconds from the start of the program chain, and number of frames corresponding to the content of interest. It is understood that bookmarks and/or bookmark/watchpoint pairs may be used to allow different functionality. This includes not only being able to start playback at the beginning of a movie or at a selected episode, but also to access a favorite or memorable scene, and then return to a selection screen, or to continue to other content. Being able to automatically bookmark content in this fashion is advantageous, as it is both faster than manually bookmarking the content, and less expensive, in that the need to procure copies of every single DVD to be bookmarked is greatly reduced.

This approach also involves examination of the cell structure defined in the IFO files. In one such embodiment, the various program chains included on a DVD are examined, and an assumption is made that the longest program chain corresponds to the main feature on the DVD. Next, the shorter program chains are examined, in order to attempt to determine if the disc contains episodic content. If it appears that the shorter program chains correspond to episodes, individual bookmarks for each episode can be constructed from the navigation information within the IFO files. If analysis of the shorter program chains does not suggest episodic content, then the longest program chain may be assumed to be the main feature on the DVD, and a bookmark can be constructed. Additionally, some human manipulation or “grooming” of the bookmarks can be performed, to improve the end-user experience.

### Exemplary Media Server Environment

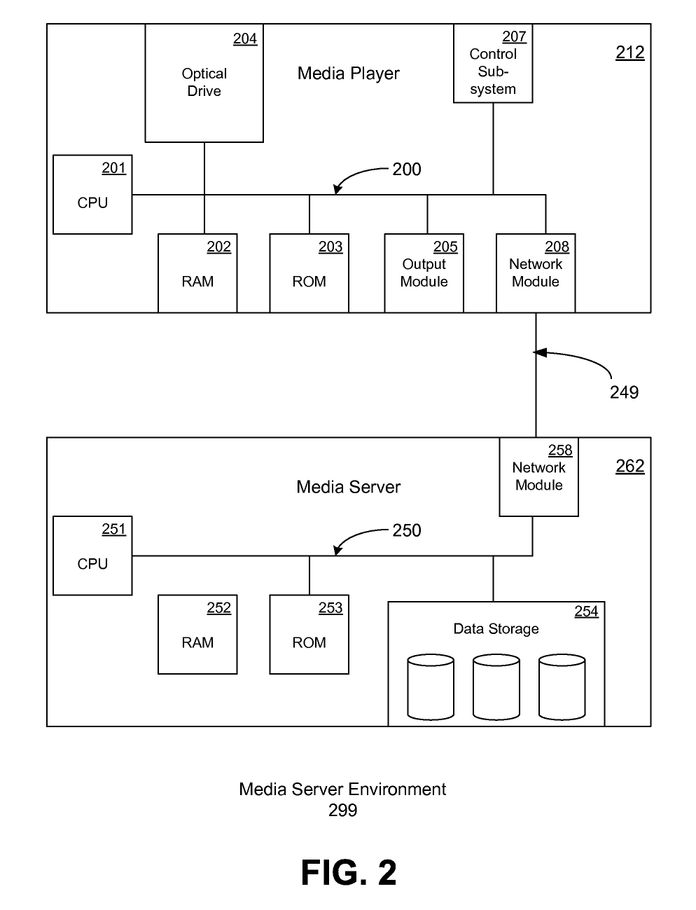

With reference now to FIG. 2, an exemplary media server environment 299 is depicted, in accordance with one embodiment. While media server environment 299 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

Media server environment 299 is shown as comprising two devices: media player 212, and media server 262. Media player 212 includes: bus 200 for communicating information; a central processor unit [CPU] 201 coupled with bus 200 for processing information and instructions; a volatile memory unit 202 (e.g., random access memory [RAM], static RAM, dynamic RAM, etc.) coupled with bus 200 for storing information and instructions for CPU 201; and a non-volatile memory unit 203 (e.g., read only memory [ROM], programmable ROM, flash memory, etc.) coupled with bus 200 for storing static information and instructions for CPU 201. Moreover, media player 212 incorporates optical drive 204, coupled with bus 200, for accessing data stored on optical media, e.g., CDs, DVDs, or Blu-Ray discs. Media player 212 also incorporates output module 205, coupled with bus 200, for outputting audio and/or video data. Media player 212 is also shown as incorporating networking module 208, coupled with bus 200, for transmitting and receiving information, e.g., over a network connection. In the depicted embodiment, media player 212 also incorporates control subsystem 207. Control subsystem 207 is coupled with bus 200, and receives control signals for controlling the functionality of media player 212, as well as for manipulating digital content being played on media player 212.

As shown in the depicted embodiment, media player 212 is communicatively coupled to media server 262 via network connection 249. In different embodiments, network connection 249 may be implemented in different ways. For example, network connection 249 may be implemented as a TCP/IP connection, transmitted via Ethernet or a wireless connection.

Media server 262 includes: bus 250 for communicating information; a CPU 251 coupled with bus 250 for processing information and instructions; a volatile memory unit 252 (e.g., random access memory [RAM], static RAM, dynamic RAM, etc.) coupled with bus 250 for storing information and instructions for CPU 251; and a non-volatile memory unit 253 (e.g., read only memory [ROM], programmable ROM, flash memory, etc.) coupled with bus 250 for storing static information and instructions for CPU 251. Media server 262 also includes data storage device 254, depicted here as a RAID array (redundant array of inexpensive disks), coupled with bus 250 for storing digital media content. Media server 262 further includes networking module 258, coupled with bus 250, for transmitting and receiving information, e.g., over a network connection.

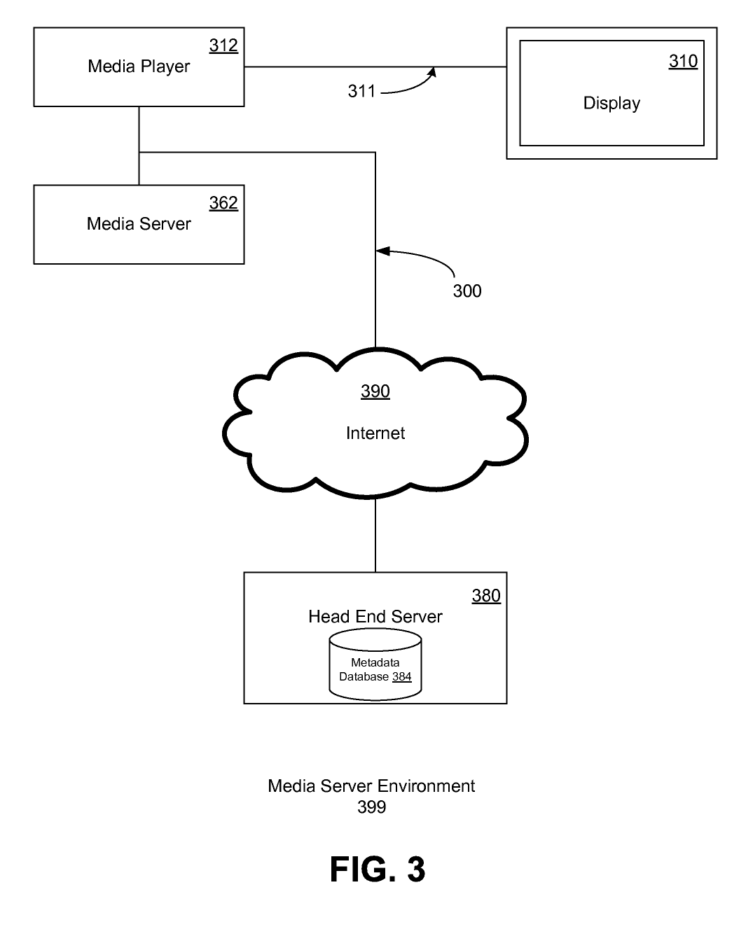

With reference now to FIG. 3, an exemplary media server environment 399 is depicted, in accordance with one embodiment. While media server environment 399 is shown as incorporating specific, enumerated features and elements, it is understood that embodiments are well suited to applications having additional, fewer, or different arrangements of features or elements. For example, the functionality described herein may be incorporated into a single physical device, or spread across additional devices.

In the depicted embodiment, media server 362 is used to store digital media content. Media server 362 is communicatively coupled with media player 312 via network connection 300. Media player 312, in the depicted embodiment, retrieves digital media content from server 362 and plays it back, e.g., by outputting digital video content over video cable 311 to display 310. Media server 362 is also communicatively coupled to a head end database 380, via network connection 300, and the Internet 390. Head end database 380 includes metadata database 384. Media server 362, in this embodiment, is configured to retrieve metadata corresponding to digital content from metadata database 384.

In different embodiments, digital media content may be available from sources other than media server 362. In one such embodiment, for example, media server 362 and/or media player 312 may be able to access or download digital media content from a remote source, e.g., head end database 380, or a remote digital media storage device (not pictured). Similarly, in some embodiments, digital media content may be available in accordance with a digital rights management (DRM) scheme, such as a “rental” scenario where digital media content is available to be viewed for a fixed length of time, or for a specified number of playbacks.

### Structure of a DVD

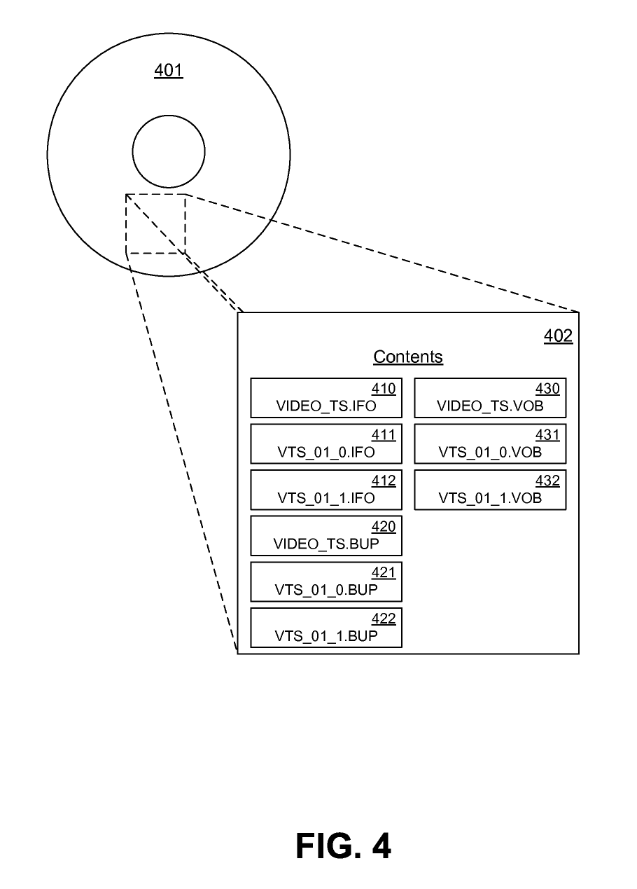

With reference now to FIG. 4, a representation of the structure of the content of a DVD 401 is depicted, in accordance with one embodiment. While DVD 401 is shown as incorporating specific, enumerated features and elements, it is understood that embodiments are well suited to applications having additional, fewer, or different arrangements of features or elements. Moreover, it is understood that embodiments are applicable to other forms of content delivery, both physical and electronic.

DVD 401 is depicted as including contents 402. Contents 402 is shown as comprising multiple files of three different types: IFO files, such as IFO files 410, 411, and 412; BUP files, such as BUP files 420, 421, and 422; and VOB files, such as VOB files 430, 431, and 432. The DVD specification calls for IFO (InFOrmation) files to be used to describe the navigation of the content included on the DVD. BUP files are backup files for the IFO files. VOB files are content containers, and hold all of the video and audio data included on the DVD.

The IFO files contain descriptions of program chains, which are used to access the content in the VOB files. A program chain has a playback time, and is divided into programs and cells. Each cell and program contained on the DVD also has a given playback time, and a playback order. In some embodiments, the “cell structure” of a particular program chain refers to the playback time and order for the cells included in the program chain, and may also include pointers into the video file corresponding to the start of the cell. Playback times within the cell structure of the program chain are extremely precise, as they refer to accessing content at a particular frame of content.

In addition, each program chain has a number of associated cell commands. Such commands occur in three varieties: “pre” commands, which execute at the start of playback of the program chain; “post” commands, which execute at the end of playback of the program chain; and cell commands that execute during playback of the program chain. Cell commands can perform different functions, e.g., instructing the playback device to begin playback of a different program chain when the current one finishes.

Each program chain belongs to a title. A title usually consists of one or more program chains with a similar theme. For example Title 1 might consist of only a single program chain representing the main feature on a disk. Title 2 may consist of 3 program chains representing 3 different short extra features such as a ‘behind the scenes’ documentary. In this case the program chains will each be numbered within the title to distinguish between them. To reference a specific program chain, both the title number of the program chain and the number of the program chain within that title are used.

Below, Table 1 illustrates the cell structure of the longest program chain on a particular DVD. In this case, the longest program chain corresponds to “Play All Episodes” on an episodic disc containing three episodes. Table 2 illustrates the cell structure for three individual program chains also included on the DVD. These program chains correspond to the three individual episodes which make up the “play all episodes” feature. As will be discussed in greater detail below, it is significant that the cell structure for each of the three episodes can be almost directly mapped into the “play all episodes” feature.

TABLE 1
Cell Structure of a “Play All Episodes” Feature

| Cell no | 1 | 2 | 3 | 4 | 5 | 6 | 7 | 8 | 9 | 10 | 11 |
|---|---|---|---|---|---|---|---|---|---|---|---|
| Time | 139.4 | 164.9 | 137.6 | 159.9 | 169.8 | 179 | 159.2 | 187.2 | 123.2 | 244.6 | 201.2 |
| Cell no | 12 | 13 | 14 | 15 | 16 | 17 | 18 | 19 | 20 | 21 | 22 |
| Time | 160 | 192 | 176 | 178.4 | 141.7 | 192 | 205.2 | 224.8 | 279.8 | 240.3 | 0.4 |

TABLE 2
Cell Structure of Three Episodes

| Episode | | | | | | | | | |
|---|---|---|---|---|---|---|---|---|---|
| number | Cell 1 | Cell 2 | Cell 3 | Cell 4 | Cell 5 | Cell 6 | Cell 7 | Cell 8 | Cell 9 |
| 1 | 139.4 | 164.9 | 137.6 | 159.9 | 169.8 | 179 | 159.2 | 187.2 | 0.4 |
| 2 | 123.2 | 244.6 | 201.2 | 160 | 192 | 176 | 178.4 | 0.4 | |
| 3 | 141.7 | 192 | 205.2 | 224.8 | 279.8 | 240.3 | 0.4 | | |

### Duplicate Features on Different Discs

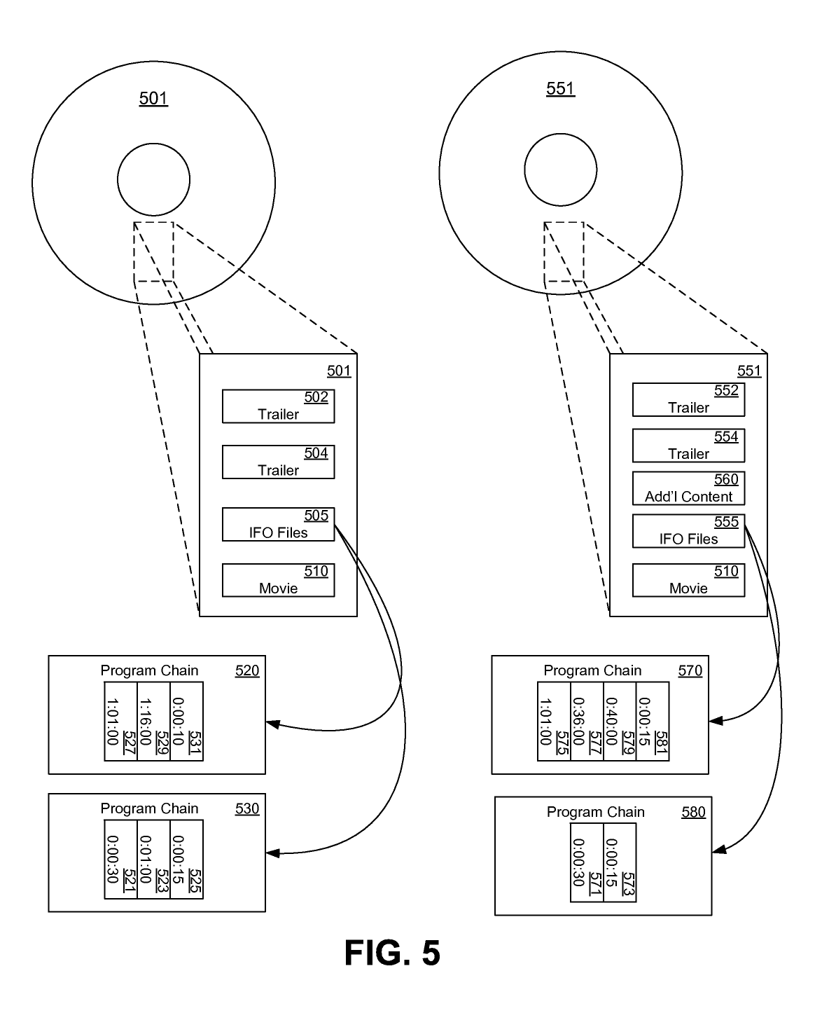

With reference now to FIG. 5, representations of the structure of the content of DVD 501 and DVD 551 are depicted, in accordance with one embodiment. While DVD 501 and 551 are shown as incorporating specific, enumerated features and elements, it is understood that embodiments are well suited to applications having additional, fewer, or different arrangements of features or elements.

FIG. 5 illustrates one of the issues arising in content identification. Two different DVDs, for example DVD 501 and DVD 551, may contain the same motion picture, e.g., movie 510. However, the other content on these discs will often differ. For example, trailers 502 and 504 are depicted as differing from trailers 552 and 554. DVD 551 also includes additional content 560, which is not present at all on DVD 501; such content is often included to distinguish between “theatrical release” and “special edition” versions of the same main feature. Additionally, sometimes the authoring of the main feature may be slightly modified between versions, resulting in a slightly different cell structure; e.g., a single chapter on the first disc may be represented by two chapters on the second disc. The result of any and all of these differences is that the structure of the information on these two DVDs will differ, as will their IFO files, e.g., IFO files 505 will differ from IFO files 555.

FIG. 5 also depicts several program chains included on each DVD. Program chain 520 includes cells 527, 529, and 531, corresponding to the main feature and an additional final element, such as a copyright notice, or a studio or production credit. Program chain 530 includes several cells 521, 523, and 525, which may indicate movie trailers, such as Trailers 502 or 504, ratings information, copyright notices, or studio or production credits. Program chain 570 includes cells 575, 577, 579, and 581. Here, the main feature corresponds to cells 575, 577, and 579; cell 581 may similarly correspond to additional information not directly related to the main feature, such as a copyright notice or a studio credit. Program chain 580 includes cells 571 and 573, which may similarly relate to other content, such as Trailers 552 or 554.

### Identifying a Collection of Media Objects by Identifying Some of the Objects

In some of these embodiments, the underlying premise is that identification of one or more media objects, e.g., cells within the cell structure of the program chain, can be used to help identify the entire collection of media objects, e.g., the main feature of a DVD, as accessed via that program chain. In order to identify individual media objects, some distinguishing characteristic must be used. In several embodiments, a “sub-identifier” can be determined from navigational information used in playback of the media objects. For example, the playback length of one or more cells within the cell structure for program chain. Sometimes, a single sub-identifier may be sufficient to identify the collection of media objects; at other times, multiple sub-identifiers may be utilized to better aid in identification. The sub-identifiers can be compared against the sub-identifiers of known collections, in order to attempt to identify the unknown collection.

In attempting to match the sub-identifiers of the unknown collection with the sub-identifiers of a specific known collection, a weighting algorithm may be utilized to give greater weight to those media objects with longer running times; in the alternative, the comparison may choose to ignore media objects having a running time below a certain threshold. Such an embodiment is useful in the cases where, for example, additional contents not related to be main feature has been inserted before or after the main feature itself; this would include such things as studio or production company identification, FBI warnings, copyright notices, or the like. Such information may change between different pressings of a DVD, but should not be allowed to prevent identification of the main feature.

Also, the comparison of sub-identifiers may test for exact equality of the sub-identifiers, or may allow for some differences, within a specified tolerance. Different regional encodings, e.g., NTSC versus PAL, may have slight variations in the cell structure of a program chain; allowing for a particular tolerance may allow for identification of a collection of media objects in spite to such differences.

In different embodiments, different calculations can be utilized to identify sub-identifiers. As such, in different embodiments, sub-identifiers may be represented by different values, e.g., scalar or vector representations. Similarly, any specified tolerance may be represented by different values, e.g., scalar or vector representations.

In some embodiments, identification of a collection of media objects proceeds automatically. In other embodiments, some human feedback may be allowed. For example, the automated identification process may identify several potential matches, within specified tolerances. These potential matches may be ranked in a linear order, perhaps with reference to the number of media objects in the collection that was matched with the unknown collection. In one such embodiment, a human user may be presented with some or all of these potential matches, and may indicate which, if any, the unknown collection best matches.

If the DVD 501 represents a “known” DVD, and DVD 551 is an “unknown” DVD, it would be beneficial to be able to identify the main feature of DVD 551 as being the same as the main feature of DVD 501. For example, if such an identification could be made automatically, metadata already associated with DVD 501 could be used in conjunction with DVD 551. The disc could be recognized and appropriately labeled with the movie title for movie 510, and ratings information, production information, cast, and summaries could be re-utilized without having to examine DVD 551. Moreover, in some embodiments, it may be possible to use bookmarks corresponding to specific scenes within the main feature of DVD 501; e.g., if the “favorite scene” bookmark was set for a portion of the main feature of DVD 501 occurring at a particular number of frames from the beginning of the cell, the appropriate offset may be calculated for that same scene on DVD 551.

In order to identify DVD 551 as containing the same main feature as DVD 501, program chains corresponding to the main features should be compared. However, as illustrated in FIG. 5, these program chains are unlikely to be completely identical. As such, the initial comparison should include some leeway. In some embodiments, a 120 second differential is useful for this initial step, as it is rare that more than 120 seconds of additional content are included in the program chain for the main feature. Other factors may also be utilized to trim the pool of likely matches, e.g., frame rate information or aspect ratio information is also available from IFO files, and can be used to eliminate unlikely matches.

Once this rough analysis is complete, the portion of the cell structure corresponding to the main feature of the known DVD can be compared with the cell structure of the main feature of the unknown DVD. Given that cell structures are precise down to a specific frame, misidentification by comparison between cell structures is unlikely. The cell structure for the main feature effectively fingerprints a particular main feature.

### Method of Content Identification

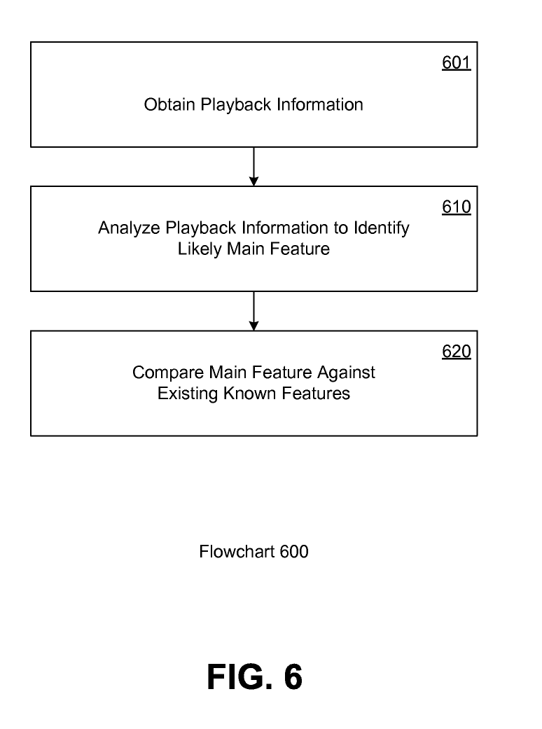

With reference now to FIG. 6, a flowchart 600 of a method of digital content identification is depicted, in accordance with one embodiment. Although specific steps are disclosed in flowchart 600, such steps are exemplary. That is, embodiments of the present invention are well suited to performing various other (additional) steps or variations of the steps recited in flowchart 600. It is appreciated that the steps in flowchart 600 may be performed in an order different than presented, and that not all of the steps in flowchart 600 may be performed.

With reference now to step 601, playback information for the digital content is obtained. For example, in the case of DVDs, the IFO files provide playback instructions in the form of program chains. The program chains, and the cells they contain, include the necessary instructions to access the content stored in the VOB files, and the ordering in which to retrieve the content.

Method 600 includes step 610. Step 610 calls for analyzing navigation information in order to identify a likely main feature within a digital content package. For example, in the case of DVDs, analysis of the IFO files is likely to identify which program chain corresponds to a likely main feature. In some embodiments, this analysis focuses on program chain playback length; if a single program chain is more than twice as long as every other program chain included on the DVD, that program chain is likely to correspond to the main feature. In one embodiment, if this determination cannot be made, the attempt to automatically identify the content will abort. In other embodiments, the identification effort will continue.

Across different embodiments, implementation details may vary. For example, digital content may be delivered on an optical storage medium, or a set of such optical discs, or it may be obtained in some other manner, e.g., downloaded and stored on a storage device like a hard drive or flash memory.

With reference now to step 620, the main feature is compared against existing known content to attempt to locate a match. For example, and again with reference to DVDs, the cell structure for the program chain including the main feature can be compared against cell structures for program chains corresponding to known features. In some embodiments, as discussed above, this step begins by performing a rough analysis, to locate known features having a similar run length within some tolerance, e.g., 120 seconds. After this rough pass, the remaining possibilities can be compared at the cell structure level against the cell structure of the main feature of the unknown DVD.

As an illustration, and with reference to the preceding figures, consider the following: DVD 501 includes movie 510, which is described by program chain 520. At some time in the past, DVD 501 was identified, and the IFO files were analyzed to identify the cell structure of program chain 520; this information is stored as part of metadata database 384, within head end server 380.

DVD 551 is newly released, and similarly contains movie 510, but with additional features included on DVD 551. As such, a conventional method of identification such as calculating a hash value would indicate that DVD 551 is different from DVD 501. When DVD 551 is inserted into media player 312, the contents may be copied to media server 362, as previously described. Media player 362 extracts IFO files 555 from DVD 551, and transmits them to head end server 380.

Head end server 380 analyzes IFO files 555, and identifies program chain 570 as being likely to correspond to the main feature. By comparing program chain 570's run length against the information stored in metadata database 384, the overall number of necessary comparisons can be reduced; similarly, as discussed above, additional information included in the IFO files may be used to constrain the set of potential matches. In the depicted embodiment, assuming a 120 second tolerance, only features with a program chain length of 2:16:15 through 2:18:15 need to be considered. In some embodiments, this initial rough analysis may be omitted.

After this rough pass, the cell structure of program chain 570 can be compared with the cell structure for main features on known DVDs stored in metadata database 384. Here, the cell structure for program chain 570 is matched with the cell structure for program chain 520; while the cells at the beginning and end of both program chains do not match, as might be expected if the information at the beginning or the end of the movie has changed, the cell structures for the majority of the content match, within tolerances. For example, cell 527 and cell 575 are identical, while cell 529 has apparently been subdivided into cells 577 and 579 during the re-authoring of DVD 551; the concatenation of cells 577 and 579 remains identical with cell 529.

### Further Examples

In order to implement the algorithm described below the following information should be extracted from the IFO files for a DVD. For each program chain in the DVD, extract: the total playback time of the program chain; the video title set number of the program chain; the number of frames per second for playback; the playback time and playback order of each program within the chain; the playback time and playback order of each cell within the chain; and the cell ID and VOB ID of each cell in the program chain.

Given two discs, embodiments may try to match all the major pieces of content from the first disc to all the major pieces of content on the second disc. A piece of content is represented by a program chain. In this example, a major piece of content is deemed to have a playback length of at least 600 seconds (10 minutes).

Assume two discs D₁ and D₂. Assume that D₁ has program chains (P₁(1), P₁(2), . . . , P₁(n)) and D₂ has program chains (P₂(1), P₂(2), . . . , P₂(m)). This embodiment attempts to match as many of the program chains as possible from each of the two discs. Note that PAL and NTSC versions of the same content will have different running times; it may be possible to normalize all running times for PAL discs by multiplying each running time for a PAL disc by 25/24.

In order to determine whether or not two program chains from two different discs represent the same piece of content, the cell structure of the program chains or the program structure of the program chains is examined. The approach is similar for both cases. This example describes use of the cell structure; a similar process would be followed for the program structure.

For a sufficiently complex piece of content, the likelihood of two unrelated pieces of content having the same cell structure is very low. The cell times are the result of the authoring process and are influenced by chapter lengths.

A certain amount of fuzziness or looseness is desirable when comparing the cell structures of two different program chains. For example, a rerelease of a DVD may be authored in a slightly different way to the original. The author may add a small amount of content to a feature such as a previously deleted scene or may decide to add an additional chapter by splitting one of the chapters on the original release into two chapters. One approach that allows for minor fluctuations is similar to the Levenstein distance between two strings; this metric is described below, and denoted as ProgD (for program chain distance).

### Computing ProgD

Given two program chains P₁ and P₂ with corresponding cell structures: C₁=(C₁(0), C₁(1), . . . , C₁(n)); C₂=(C₂(0), C₂(1), . . . , C₂(m)). Compute for each i from −1 to n and each j from −1 to m a value dist(i,j). The desired distance ProgD(P₁, P₂) will be equal to dist(n,m).

The intermediate values of dist(i,j) (i.e. those where either 0<i<=n or 0<j<=m) can be interpreted to be the ProgD distance between the program chains with cell structures (C₁(1), C₁(2), . . . , C₁(i)) and (C₂(1), C₂(2), . . . , C₂(j)). Recursively compute each dist(i,j).

Begin by setting dist(−1, −1)=0. Next, set dist(−1,j)=dist(0,j)=dist(0,j−1)+C₂(j) for all 0<=j<=m. Similarly, define dist(i,0)=dist(i,−1)=dist(i−1,0)+C₁(i) for all 0<=i<=n. Now fixing 1<=j<=m, define for each 1<=i<=n:
dist(i,j)=min(dist(i,j−1)+C₂(j),
   dist(i−1,j)+C₁(i),
         |C₂(j)-C₁(i−1)-C₁(i)|+dist(i−2,j−1)+RCost,
         |C₁(i)-C₂(j−1)-C₂(j)|+dist(i−1,j−2)+RCost,
   dist(i−1,j−1)+|C₁(i)-C₂(j)|).

Each of the terms that are arguments in the min function can be interpreted as follows:
dist(i,j−1)+C₂(j): adding an extra cell C₂(j) increases the distance by the running time of that cell;
dist(i−1,j)+C₁(i): adding an extra cell C₁(i) increases the distance by the running time of that cell;
   |C₂(j)-C₁(i−1)-C₁(i)|+dist(i−2,j−1)+RCost: adding an extra cell C₂(j) which joins together the two cells C₁(i−1) and C₁(i) increases the distance by the difference between the running time of the added cell and the combined running time of the two cells joined together, plus adds an additional distance RCost as a penalty for this operation;
   |C₁(i)-C₂(j−1)-C₂(j)|+dist(i−1,j−2)+RCost: as for the previous term with the roles of C₁ and C₂ reversed;
dist(i−1,j−1)+|C₁(i)-C₂(j)|: adding both cells C₁(i) and C₂(j) increases the distance by the difference in running times of each cell.

The parameter RCost is fixed; a value of 10 works well.

The following is an example of the computation of ProgD for two program chains P₁ and P₂. P₁=(4, 10, 12, 3, 8); P₂=(2, 4, 5, 5, 11, 11). RCost=10.

TABLE 3
Values of dist(i, j) for RCost = 10.

| | i = −1 | i = 0 | i = 1 | i = 2 | i = 3 | i = 4 | i = 5 |
|---|---|---|---|---|---|---|---|
| j = −1 | 0 | 0 | 4 | 14 | 26 | 29 | 37 |
| j = 0 | 0 | 0 | 4 | 14 | 26 | 29 | 37 |
| j = 1 | 2 | 2 | 2 | 12 | 24 | 27 | 35 |
| j = 2 | 6 | 6 | 2 | 8 | 20 | 23 | 31 |
| j = 3 | 11 | 11 | 7 | 7 | 15 | 18 | 26 |
| j = 4 | 16 | 16 | 12 | 12 | 14 | 17 | 21 |
| j = 5 | 27 | 27 | 23 | 13 | 13 | 16 | 20 |
| j = 6 | 38 | 38 | 34 | 24 | 14 | 17 | 19 |

The sequence of steps from P₂ to P₁ illustrates the calculation of the final distance of 19. To start, note that ProgD (P₂, P₂)=0. Change P₂ into P₁ one step at a time. At each intermediate stage, P denotes the transformed vector, and ProgD (P₂, P) is shown.

Discard the first cell time to get P=(4, 5, 5, 11, 11).

ProgD (P₂, P)=2.

Next change the second cell time in P from 5 to 10 to get P=(4, 10, 5, 11, 11).

ProgD (P₂, P)=2+(10−5)=7.

Discard the third cell time in P to get P=(4, 10, 11, 11).

ProgD (P₂, P)=7+5 =12.

Change the third cell time in P from 11 to 12 to get P=(4, 10, 12, 11).

ProgD (P₂, P)=12+(12−11)=13.

Change the fourth cell time in P from 11 to 8 to get P=(4, 10, 12, 8).

ProgD (P₂, P)=13+(11−8)=16.

Add a new cell time of 3 between the third and fourth cell time in P to get P₁=(4, 10, 12, 3, 8).

ProgD (P₂, P₁)=16+3=19.

Perform the same computations with RCost=1 this time to illustrate the impact of the parameter RCost.

TABLE 3
Values of dist(i, j) for RCost = 1.

| | i = −1 | i = 0 | i = 1 | i = 2 | i = 3 | i = 4 | i = 5 |
|---|---|---|---|---|---|---|---|
| j = −1 | 0 | 0 | 4 | 14 | 26 | 29 | 37 |
| j = 0 | 0 | 0 | 4 | 14 | 26 | 29 | 37 |
| j = 1 | 2 | 2 | 2 | 12 | 24 | 27 | 35 |
| j = 2 | 6 | 6 | 2 | 8 | 20 | 23 | 31 |
| j = 3 | 11 | 11 | 7 | 4 | 15 | 18 | 26 |
| j = 4 | 16 | 16 | 12 | 3 | 11 | 14 | 21 |
| j = 5 | 27 | 27 | 23 | 13 | 4 | 7 | 12 |
| j = 6 | 38 | 38 | 34 | 24 | 14 | 12 | 5 |

Discard the first cell time to get P=(4, 5, 5, 11, 11).

ProgD (P₂, P)=2.

Combine the second and third cell time in P to get P=(4, 10, 11, 11).

ProgD (P₂, P)=2+RCost=2+1=3.

Change the third cell time in P from 11 to 12 to get P=(4, 10 , 12, 11).

ProgD (P₂, P)=3+(12−11)=4.

Split the fourth cell time in P into two cell times of 3 and 8 to get P₁=(4, 10, 12, 3, 8).

ProgD (P₂, P₁)=4+RCost=4+1=5.

### Deciding if Two Program Chains are Sufficiently Similar:

To compare two program chains P₁ and P₂ with corresponding cell structures C₁ and C₂, first ensure that each cell structure contains a sufficient variety of cell times. Some DVDs are authored in such a way that the cell times are uniform and do not reflect the nature of the content. One approach involves detecting the number of cells clustered around a common running time. Start by sorting cells by running time and discarding cells with times that are within 5 seconds of the shortest running time; these discarded cells comprise a cluster. Continue discarding cells in this manner while counting clusters. If at least 5 clusters are detected then the cell structure likely has sufficient variety to use as a comparison. It is understood that other approaches may be utilized, including various standard statistical tests or known tests for randomness.

Assuming that both P₁ and P₂ pass this test, determine whether or not they are a match. First calculate ProgD(P₁, P₂). Now let l(P₁) be the total running time of P₁ and define l(P₂) similarly. Test whether ProgD(P₁, P₂)/min(l(P₁), l(P₂))<tol, where tol is a fixed parameter that allows us to control how accurate the match should be. In some embodiments, 0.01 gives adequate results. If P₁ and P₂ satisfy the inequality above, they are likely a match.

### Analyzing All Program Chains

In some embodiments, it is worthwhile to consider all of the program chains on a disc. One approach, described herein as test A, is to determine whether (P₁(1), P₁(2), . . . , P₁(n)) is identically equal to (P₂(1), P₂(2), . . . , P₂(m)). This means that the cell structure of each program chain on D₁ is exactly the same as the cell structure of a corresponding program chain on D₂. For test A, include all program chains, not just those with a running time of over 600 seconds. Test A works infrequently, however, when it does, it gives a high degree of certainty to the match between D₁ and D₂.

If test A fails, another approach, test B, begins by discarding all program chains with a running time under 600 seconds. For convenience, assume that the lists of program chains are still (P₁(1), P₁(2), . . . , P₁(n)) and (P₂(1), P₂(2), . . . , P₂(m)). Test B will try and find a one-to-one correspondence between the program chains in D₁ onto those from D₂. We first check that n=m. If this is not the case then test B automatically fails. Next for each P₁(i) ensure that there is at least one P₂(j) that matches P₁(i). If there is not at least one match for each P₁(i) then test B fails. Finally, check every permutation of (P₁(1), P₁(2), . . . , P₁(n)) against (P₂(1), P₂(2), . . . , P₂(m)) to see if the corresponding program chains match. Permute the elements of (P₁(1), P₁(2), . . . , P₁(n)) and check the first element in the permuted array against P₂(1), the second against P₂(2) etc. If there is a permutation that provides a complete match for all the program chains then the discs pass test B.

If test B also fails, another approach, test C, involves trying to match the longer program chains from each disc. For convenience assume that P₁(1) is the longest program chain with running time l(P₁(1)). The longer program chains can be defined as those program chains, P₁(i) satisfying:

l(P₁(1))/l(P₁(i))<2.1

In a disc of episodic content such program chains would likely represent episodes and exclude extras, trailers etc.

If (P₁(1), P₁(2), . . . , P₁(n)) is the set of longer program chains from D₁ and (P₂(1), P₂(2), . . . , P₂(m)) is the set of longer program chains of D₂, apply test B to these two sets of program chains. If these pass test B, then the two discs pass test C.

Another approach, test D, simply tries to match the longest program chain from D₁ with the longest program chain from D₂. This works well in most cases where the discs contain a single main feature and number of pieces of additional content. Test D can be used to conclude that the two discs have the same main feature, but perhaps different trailers or extras.

### Variations

The above embodiments are understood not to be limited to the sort of client/server/head end server architecture depicted in FIG. 3. Embodiments are well suited to applications on many different architectures, including but not limited to client/server, client/head end server, or standalone applications.

### Automatic Bookmark Generation

As previously discussed above, navigation information provided with digital content may also be used to generate bookmark information for their digital content. In some cases, this generation can be performed without the need for human intervention; moreover, in some cases, bookmarks can be generated without the need to examine the content itself.

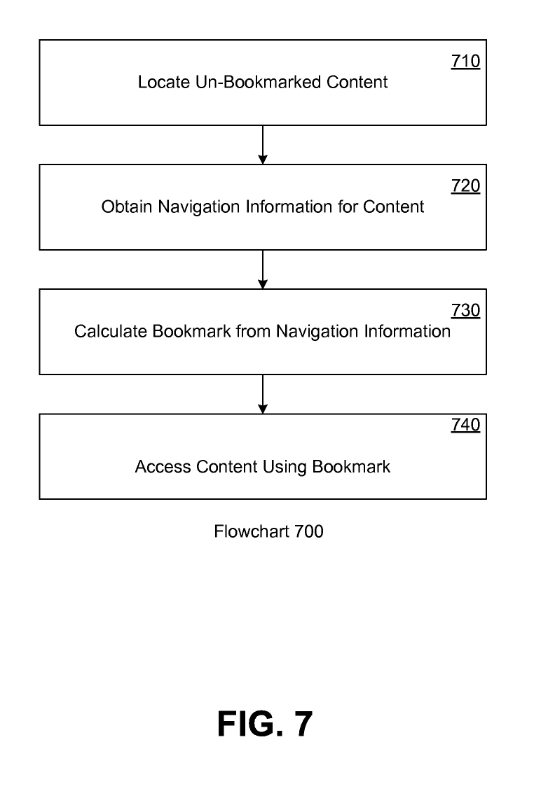

With reference now to FIG. 7, a flowchart 700 of a method of automatically generating bookmarks for digital content is depicted, in accordance with one embodiment. Although specific steps are disclosed in flowchart 700, such steps are exemplary. That is, embodiments of the present invention are well suited to performing various other (additional) steps or variations of the steps recited in flowchart 700. It is appreciated that the steps in flowchart 700 may be performed in an order different than presented, and that not all of the steps in flowchart 700 may be performed.

With reference now to step 710, un-bookmarked digital content is located. In some embodiments, this digital content may be stored on or available through a media playback device, e.g., content stored on media server 262 for playback on media player 212. In other embodiments, this digital content may be stored or available through another source, e.g., available for download or playback via an “on-demand” service.

With reference now to step 720, navigation information for the digital content is obtained. In some embodiments, navigation information is readily available; e.g., the IFO files stored on the DVD containing the digital content. In other embodiments, the navigation information may need to be extracted from the digital content, or obtained via a capture mechanism during playback of digital content.

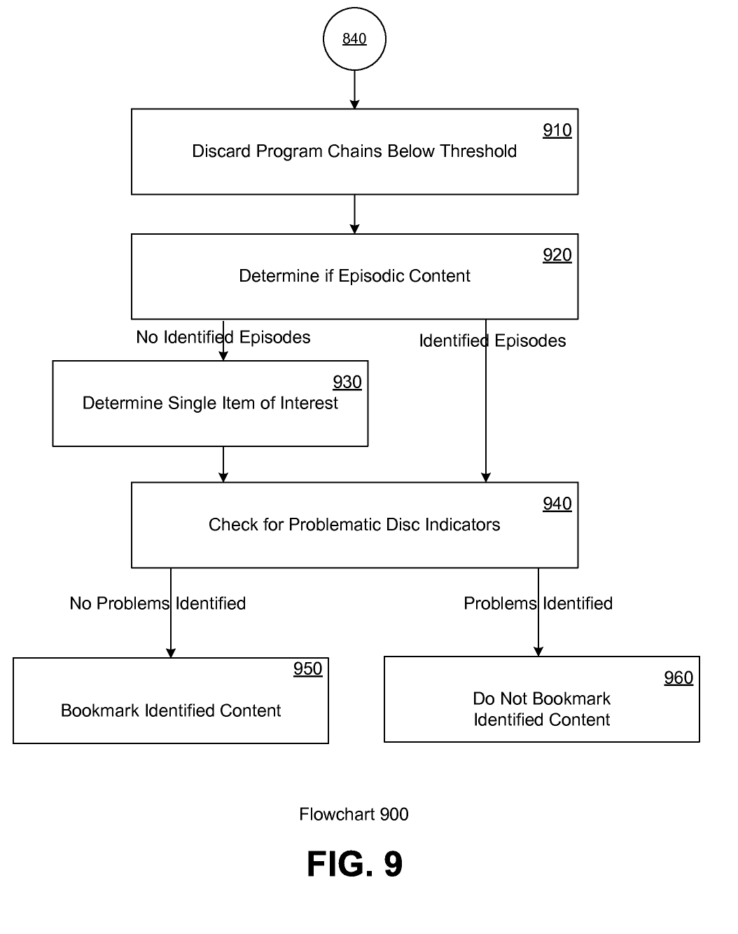

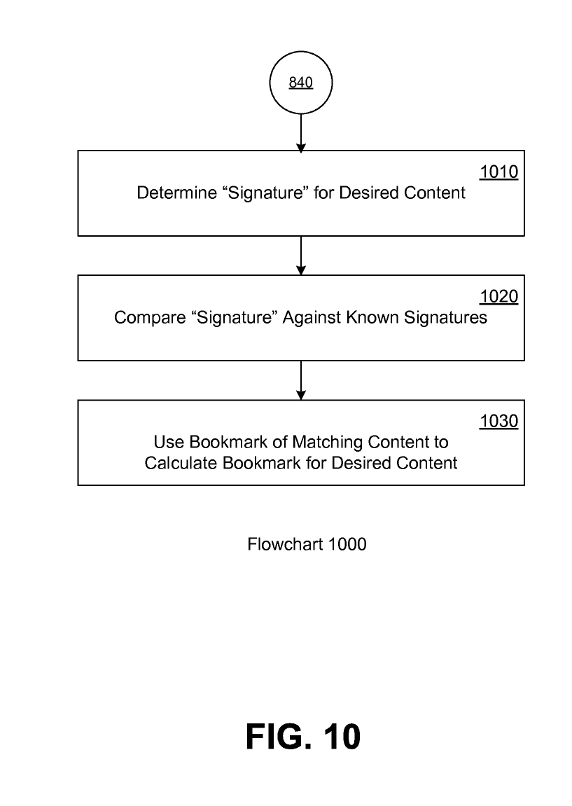

With reference now to step 730, a bookmark for a location within the digital content is calculated, with reference to the navigation information. In different embodiments, different approaches may be utilized for calculating this bookmark. Several such embodiments are described below in greater detail, with reference to FIGS. 9 and 10.

In different embodiments, the calculation may be performed at different locations. For example, in one embodiment, a local media server or playback device, such as media server 262, may calculate an appropriate bookmark for digital content available via that media server or playback device. In another embodiment, bookmarks may be calculated for content at some centralized or “head end” location, such as head end server 380.

With reference now to step 740, the calculated bookmark can be utilized to access the digital content. In some embodiments, the calculated bookmark is distributed to one or more playback devices, such that these playback devices may utilize the bookmark in accessing the digital content. In one such embodiment, a centralized server distributes the calculated bookmark to a number of client devices; e.g., head end server 380 distributes the calculated bookmark to one or more media servers 362.

### Method of Remotely Generating Bookmarks for DVD Content

In one embodiment, IFO files included on a DVD can be used to automatically generate bookmarks for some of the content included on the DVD.

With reference now to FIG. 8, a flowchart 800 of a method of remotely generating bookmarks for DVD content is depicted, in accordance with one embodiment. Although specific steps are disclosed in flowchart 800, such steps are exemplary. That is, embodiments of the present invention are well suited to performing various other (additional) steps or variations of the steps recited in flowchart 800. It is appreciated that the steps in flowchart 800 may be performed in an order different than presented, and that not all of the steps in flowchart 800 may be performed.

With reference now to step 810, inventory records corresponding to digital content are obtained. In some embodiments, these inventory records may correspond to the content loaded into or accessible via a media server, such as media server 262. In one such embodiment, the inventory records contain unique identification information for the digital content, such as uniquely-identifying hash values for every DVD loaded into the media server. In some embodiments, these inventory records may be transmitted to a remote location, such as head end server 380.

With reference now to step 815, in some embodiments, the inventory records are used to identify digital content for which no bookmarking information has been calculated. Such an embodiment would identify unknown digital content, “known” content which has not been bookmarked, and digital content which has been re-authored, e.g., a new DVD release of a classic movie, where previous DVD releases of that movie had been bookmarked.

With reference now to step 820, navigation information is obtained for an un-bookmarked piece of digital content. In some embodiments, where DVDs are utilized, IFO files can be extracted from an un-bookmarked DVD and transmitted as necessary. For example, media server 362 stores images of DVDs. An un-bookmarked DVD is identified by head end server 380, and media server 362 is instructed to extract the IFO files from the corresponding image of the DVD. These IFO files are then transmitted to head end server 380, for use in generating bookmarks. IFO files are well suited to such an embodiment, as they are relatively small files, as compared to the size of the files on a DVD containing digital content.

With reference now to step 830, playback information is extracted from the navigation information corresponding to the un-bookmarked piece of digital content. In the case of DVDs with IFO files, this playback information may correspond to program chains and the resulting cell structure.

In some embodiments, the preceding steps are performed differently, or in a different order. In one such embodiment, navigation information is obtained for digital content, e.g., IFO files are obtained for every DVD containing digital content, unless the head end server already has access to IFO files for a given DVD. Playback information is then extracted from all navigation information. Unbookmarked digital content is then identified.

With reference now to step 840, a bookmark is calculated from the extracted playback information. In different embodiments, this step is performed in different ways. Several embodiments corresponding to this step are examined in greater detail below, with reference to FIG. 9. As discussed previously, in some embodiments a terminal bookmark and/or watchpoint may also be calculated from the playback information.

With reference now to step 850, the generated bookmark may pass through a “grooming” process. In some embodiments, it is desirable that the bookmark be tested in order to ensure proper functionality. Additionally, in some embodiments, some of metadata may be used to provide greater utility with the generated bookmark. For example, episodic content may have individual episode names associated with episodic bookmarks, or “Play Concert” may be used to identify a bookmark for a concert video, rather than simply “Play Feature.” Finally, in some embodiments, generated bookmarks that satisfy a set of constraints may be automatically approved without requiring manual testing. For example, the run length of bookmarked content may be compared with metadata about the content, e.g., a known run time for the feature contained on the disc; if the two lengths are similar, the bookmark may be automatically approved, without requiring human oversight. Alternatively, generated bookmarks which meet certain conditions may be prevented from such automatic approval, e.g., if the content is of a specific genre, or from a specific studio, or is associated with supplemental or bonus discs for boxed sets.

With reference now to step 860, the bookmark is transmitted to the playback device. For example, the bookmark may be transmitted from head end server 380 to media server 362, for use in playing back the previously unbookmarked DVD on media player 312.

Calculating Bookmarks from Navigation Information

With reference now to FIG. 9, a flowchart 900 of a method of calculating bookmarks from navigation information is depicted, in accordance with one embodiment. Although specific steps are disclosed in flowchart 900, such steps are exemplary. That is, embodiments of the present invention are well suited to performing various other (additional) steps or variations of the steps recited in flowchart 900. It is appreciated that the steps in flowchart 900 may be performed in an order different than presented, and that not all of the steps in flowchart 900 may be performed.

In one embodiment, method 900 may be utilized in conjunction with method 800, e.g., method 900 may be used at step 840 in order to calculate bookmarks.

With reference now to step 910, playback information extracted from navigation information for digital content is examined, and filtered with reference to preestablished threshold values. For example, when attempting to bookmark a DVD, program chains, extracted from IFO files, which are below a certain length threshold may not need to be considered while attempting to bookmark the DVD. In one embodiment, program chains with a total running length of less than 10 minutes may be safely discarded, as they are extremely unlikely to correspond to either a feature length film, or individual episodes within episodic content. In other embodiments, other threshold values may be utilized, in order to achieve different results.

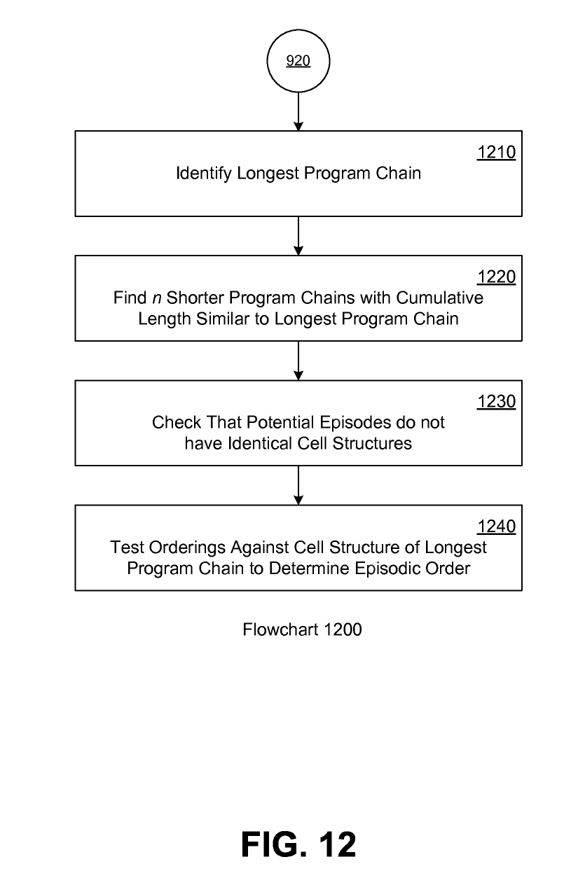

With reference now to step 920, the filtered playback information is further examined, in order to attempt to determine whether the digital content corresponds to episodic content. In some embodiments, it is desirable to identify episodic content, in order to provide bookmarks for each episode contained within the digital content. As such, these embodiments are likely to handle bookmarking episodic content in a slightly different manner than digital content with a single “feature” item. In different embodiments, this step is performed in different ways. Several such embodiments are examining greater detail below, with reference to FIG. 12.

With reference now to step 930, if the digital content does not appear to be episodic, the single item most likely to be of interest is determined. In many embodiments, digital content contains a single “feature” item, such as the movie included on a DVD. The digital content may also contain many other items. In one embodiment,

In some embodiments, digital content may contain multiple “long” play items. In several such embodiments, analysis of these play items may be utilized to allow bookmarking. For example, if two program chains are similar in cell structure, but one indicates that playback should be performed using a widescreen aspect ratio, and the second indicates that playback should be performed using a fullscreen aspect ratio, both play items may be bookmarked, perhaps with an appropriate indicator on the bookmark to indicate aspect ratio. As another example, analysis of the offsets in the cell structure of both program chains may indicate that the two program chains may actually indicate playback of the same content, if the offsets indicated are sufficiently similar.

With reference now to step 940, the navigation information for the digital content is examined for problematic factors. In some embodiments, it is possible to determine the likelihood of success of the automatic bookmark generating process by examining the digital content for certain identified problematic factors. For example, with reference to DVDs, IFO files may contain cell commands. It has been experimentally determined that program chains having unusually large numbers of cell commands, or cells having zero playback time (which may also contain cell commands), are more likely to have problems beginning playback from the locations bookmarked by this process. Other problematic factors may also be considered: for example, discs from a certain publisher may be more likely to include mal-authored information, and so may be excluded; additionally, discs which are identified as being alternative versions of known problematic discs may be excluded as well. In several such embodiments, no attempt is made to automatically bookmark these DVDs, as a broken bookmark may provide greater frustration to an attempted end user than no bookmark at all. In other embodiments, an automatically generated bookmark may still be produced, either to allow it to be manually adjusted at a later time, or to allow the end user to attempt to make use of the bookmark.

With reference now to step 950, a bookmark is generated for the digital content. As discussed above, and in the incorporated disclosures, different approaches to generating or creating a bookmark may be used, as appropriate. In different embodiments, a bookmark will need to contain different information. In one such case, bookmarking a DVD involves identifying the title number, program chain number, time in seconds from the start of the program chain, and number of frames corresponding to the content of interest; in another case, identifying the program chain of interest, and instructing a media player to initiate playback of a media object at the indicated program chain may be adequate.

With reference now to step 960, no bookmark is generated for the digital content. As discussed above, some embodiments do not generate bookmarks when the problematic factors are identified within the digital content. Moreover, if step 920 cannot identify individual episodes within the digital content, and at step 930 cannot identify a single “feature” item, it may not be desirable to generate bookmarks.

Calculating Bookmarks from Playback Duration “Signatures”

With reference now to FIG. 10, a flowchart 1000 of a method of calculating bookmarks from playback duration signatures is depicted, in accordance with one embodiment. Although specific steps are disclosed in flowchart 1000, such steps are exemplary. That is, embodiments of the present invention are well suited to performing various other (additional) steps or variations of the steps recited in flowchart 1000. It is appreciated that the steps in flowchart 1000 may be performed in an order different than presented, and that not all of the steps in flowchart 1000 may be performed.

In one embodiment, method 1000 may be utilized in conjunction with method 800, e.g., method 1000 may be used at step 840 in order to calculate bookmarks.

With reference now to step 1010, a “signature” for a particular piece of content is determined. In some embodiments, playback duration information is extracted from the digital content. In one embodiment, chapter length information and playback order is obtained from the program chains described in the IFO files available on a DVD; in other embodiments, chapter length and playback order may be obtained in other ways. In many cases, the combination of chapter length and playback order is sufficient to uniquely identify a particular piece of content on a DVD, such as the main feature; this combination is referred to herein as the “signature” of the content. In other embodiments, other information may be utilized to determine the signature of the content, such as the playback duration or cell structure of individual program chains.

With reference now to step 1020, the signature of the particular piece of content is compared with one or more signatures of known, bookmarked content. If the signature for the particular piece of content is similar to the signature of a known, bookmarked piece of content, the two pieces of content may be the same. This may occur when a piece of content is included in several different packages of digital content, such as multiple pressings of a DVD with the same feature. This process can be further simplified if the digital content can be identified, e.g., by examination of a UPC code included with a DVD; the comparison, in such a case, could be limited to signatures of content.

With reference now to step 1030, a bookmark is calculated for the particular piece of content is calculated, with reference to the bookmark for the matching content identified above. In one embodiment, the values used by the bookmark for the known content may be used to help calculate the bookmark for the particular piece of content, e.g., by using a similar offset to enter a program chain, or by using similar register values.

For example, the signature of the likely main feature on a DVD can be compared against a database containing signatures of previously-bookmarked content. If the DVD was first identified, e.g., by use of its UPC code, then the comparison may be limited to the signatures of previously-bookmarked content from similarly-titled DVDs; alternatively, the comparison process may begin with such signatures, and expand to other items if necessary. If the signature of a known, bookmarked item is similar to the signature of the likely main feature, then the bookmark of the matching item may be used to help calculate an appropriate bookmark for the likely main feature, e.g., by using the offset into the video file from the known bookmark.

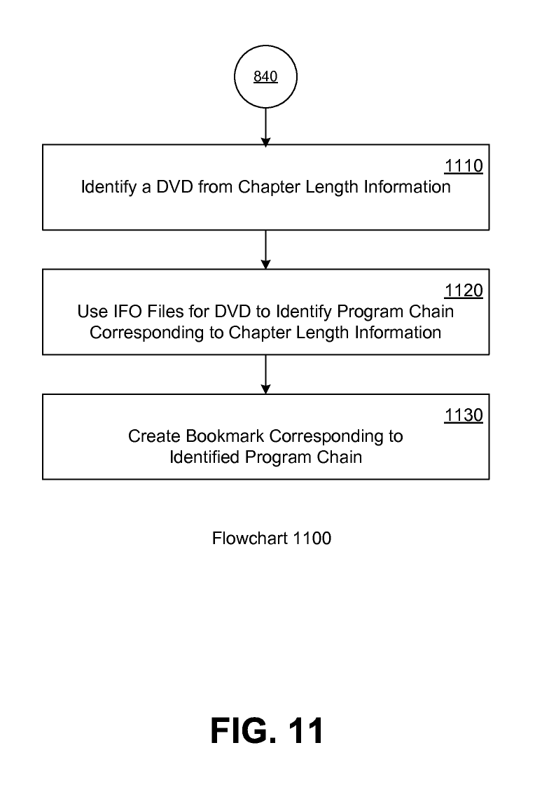

With reference now to FIG. 11, a flowchart 1100 of a method of calculating bookmarks from playback duration signatures is depicted, in accordance with one embodiment. Although specific steps are disclosed in flowchart 1100, such steps are exemplary. That is, embodiments of the present invention are well suited to performing various other (additional) steps or variations of the steps recited in flowchart 1100. It is appreciated that the steps in flowchart 1100 may be performed in an order different than presented, and that not all of the steps in flowchart 1100 may be performed.

With reference now to step 1110, an unknown DVD is identified from chapter length information. In some embodiments, a database of chapter length information is available, e.g., from a third-party provider. This chapter length information can be used to identify DVDs, in the same manner as track lengths on a CD can be used to identify a CD, as the chapter lengths for the main feature of a given DVD tend to be unique.

With reference now to step 1120, the IFO files for the DVD are used to identify the program chain corresponding to the main feature. In some embodiments, the IFO files are examined, to find the program chain which corresponds to the chapter length information used to identify the DVD.

With reference now to step 1130, a bookmark is created to point to the main feature program chain. In some embodiments, a bookmark can be created to access the digital content at the start of the program chain corresponding to the main feature.

### Identifying Episodic Content

With reference now to FIG. 12, a flowchart 1200 of a method of identifying episodic content is depicted, in accordance with one embodiment. Although specific steps are disclosed in flowchart 1200, such steps are exemplary. That is, embodiments of the present invention are well suited to performing various other (additional) steps or variations of the steps recited in flowchart 1200. It is appreciated that the steps in flowchart 1200 may be performed in an order different than presented, and that not all of the steps in flowchart 1200 may be performed.

In one embodiment, method 1200 may be utilized in conjunction with method 900, e.g., method 1200 may be used at step 920 in order to calculate bookmarks.

With reference now to step 1210, navigation information corresponding to digital content is examined, in order to identify the item within the digital content with the greatest playback duration. In some embodiments, the step involves examining the program chains included in the IFO files for DVD content, in order to identify the longest program chain defined by the IFO files. In many cases, the longest program chain on a disc of episodic content will correspond to a “Play All” feature or program chain.

With reference now to step 1220, the navigation information is further examined, in order to identify a number of items within the digital content with a cumulative playback duration similar to the item with the greatest playback duration identified in step 1210. In some embodiments, navigation information for individual episodes on a DVD can be identified. The cumulative playback length for every individual episode on the DVD should be similar to the total playback length of the longest item on the disc, if the longest item on the disc corresponds to a “Play All” feature. In some embodiments, filters may be used to limit the amount of navigation information which needs to be examined; for example, as most television episodes correspond to 30 minute or 60 minute timeslots, it may be safe to ignore program chains with a duration of less than 10 minutes.

With reference now to step 1230, the navigation information for the potentially-identified episodes is examined, in order to ensure that the navigation information is not identical for each. Some digital content is subdivided mechanically, and without regard to the content itself, such that the navigation information for one portion of the content is similar to the navigation information for another portion of the content. In some

With reference now to step 1240, the ordering of the episodes within the digital content is determined. In some embodiments, the navigation information for each presumed episode is compared with the navigation information for the presumed “Play All” feature. Various orderings of episodes can be tried, until the order of playback of episodes in the “Play All” feature is determined. For example, the cell structures within the program chains for individual episodes can be compared with the cell structure of the program chain for the “Play All” feature; so long as the episodes do not have identical cell structures, they will only fit into the program chain for the “Play All” feature in one particular ordering. This ordering can be used to determine which is the first episode on the disc, which the second, etc. Moreover, in conjunction with access to metadata which identifies the disc itself, it is possible to identify the episode within a greater series of discs; e.g., episode three on disc four of a DVD series is episode 15 of that particular series, and the appropriate title for that episode may be available.

Embodiments of the present invention are thus described. While the present invention has been described in particular embodiments, it should be appreciated that the present invention should not be construed as limited by such embodiments, but rather construed according to the following claims.

What is claimed is:

1. A method of bookmarking digital content, comprising:
locating said digital content;
obtaining navigation information associated with said digital content; and
calculating bookmark information from said navigation information.

2. The method of claim 1, further comprising:
accessing said digital content utilizing said bookmark information.

3. The method of claim 1, wherein said locating comprises examining a plurality of digital content stored on or available through a media server, in order to identify said digital content.

4. The method of claim 1, wherein said digital content comprises a DVD, and said obtaining comprises accessing an IFO file associated with said DVD.

5. The method of claim 4, wherein said calculating comprises:
examining a plurality of program chains described in said IFO file to determine a feature item within said digital content.

6. The method of claim 5, wherein said calculating further comprises:
filtering said plurality of program chains according to preestablished threshold values.

7. The method of claim 1, further comprising:
examining said digital content for known problematic factors.

8. A method of bookmarking digital content, comprising:
obtaining navigation information associated with said digital content;
extracting playback information from said navigation information; and
calculating a bookmark for said digital content, with reference to said playback information.

9. The method of claim 8, further comprising:
obtaining inventory records from a remote device;
examining said inventory records to determine whether said digital content has been bookmarked; and
requesting said navigation information from said remote device.

10. The method of claim 8, further comprising:
delivering said bookmark to a remote device, for use in accessing said digital content.

11. The method of claim 8, wherein said calculating comprises:
determining if said digital content comprises episodic content;
if said digital content does comprise episodic content, identifying a plurality of episodes within said digital content;
if said digital content does not comprise episodic content, determining a feature item within said digital content; and
calculating a bookmark for said digital content.

12. The method of claim 11, wherein said playback information comprises a plurality of program chains.

13. The method of claim 12, wherein determining if said digital content comprises episodic content comprises:
identifying a longest program chain from said plurality of program chains; and
finding a subset of said plurality of program chains such that a cumulative length of said subset is similar to said longest program chain.

14. The method of claim 13, further comprising:
checking that each program chain within said subset comprises a different cell structure.

15. The method of claim 13, further comprising:
determining an order of episodes by comparing cell structures of program chains within said subset with said longest program chain.

16. A system for calculating a bookmark for digital content, comprising:
a bus for communicating information;
a processor, coupled to said bus, for processing information and instructions;
a memory, coupled to said bus, for storing said instructions; and
a storage device, coupled to said bus, for storing navigation information associated with said digital content,
wherein said processor is configured to perform said instructions in order to:
extract playback information from said navigation information; and
calculate said bookmark for said digital content.

17. The system of claim 16, wherein said bookmark comprises:
a title number;
a program chain number;
a time offset; and
a frame offset.

18. The system of claim 16, wherein said storage device is also for storing said digital content.

19. The system of claim 16, further comprising:
a network connection, coupled to said bus, for receiving said navigation information from a remote device.

20. The system of claim 16, wherein said processor is further configured to:
examine said playback information to identify a longest program chain;
examine a plurality of program chains within said playback information, to determine whether a combination of program chains is similar in length to said longest program chain exists; and
if said combination exists, calculate a plurality of bookmarks for said digital content.
